(19) United States
(12) Patent Application Publication
(10) Pub. No.: US 2019/0026410 A1
(43) Pub. Date: Jan. 24, 2019

(54) STRATEGIC IMPROVISATION DESIGN FOR ADAPTIVE RESILIENCE

(71) Applicant: Siemens Aktiengesellschaft, München (DE)

(72) Inventors: Arquimedes Martinez Canedo, Plainsboro, NJ (US); Sanjeev Srivastava, Princeton, NJ (US); Lucia Mirabella, Plainsboro, NJ (US)

(21) Appl. No.: 16/067,047

(22) PCT Filed: Feb. 3, 2017
(86) PCT No.: PCT/US2017/016322

§ 371 Date: Jun. 28, 2018

Related U.S. Application Data
(60) Provisional application No. 62/291,004, filed on Feb. 4, 2016.

(51) Int. Cl. G06F 17/50; G06F 17/30; G06Q 10/06

(52) U.S. Cl. CPC G06F 17/5009; G06F 17/30377; G06F 17/30734; G06Q 10/06375; G06F 17/3053

(57) ABSTRACT

A method for providing adaptive resilience to a system defined by physical components includes generating an ontology comprising objects. Each object corresponds to (i) functions performed by a discrete physical component of the system; (ii) behaviors of the discrete physical component; (iii) physical structures included in the discrete physical component; and (iv) events that impact usage of the discrete physical component. Relationships are added to the ontology for each physical component including aggregation relationships, composition relationships, and dependencies between the physical components. Sensor data is received from sensors monitoring the physical components. Based on the data, an event is identified that is impacting physical components performing a system function. The ontology's attributes and relationships are used to generate an alternate system design comprising physical components that are functionally equivalent to the impacted components with respect to the system function. Then, the alternate system design is sent to users.

### CROSS-REFERENCE TO RELATED APPLICATIONS

This application claims the benefit of U.S. Provisional Application Ser. No. 62/291,004 filed Feb. 4, 2016, which is incorporated herein by reference in its entirety.

### TECHNICAL FIELD

The present disclosure generally relates to systems, methods, and apparatuses for designing a complex system-of-systems for planning and adaptation to unplanned scenarios. The techniques described herein may be applied for example, the modeling of any complex system.

### BACKGROUND

Currently, dynamic complex system-of-systems like urban infrastructures are difficult to model and impossible to systematically design; thus leading to: inferior performance; unexpected problems; and weak resilience, especially to other unplanned scenarios. Typically, conventional planning tools are used to simulate a large number of pre-planned scenarios and to identify how modifications to the system would perform under each of them. This approach results in system designs that are likely to perform well under certain emergency scenarios, but cannot provide information on how to adapt the system to scenarios that have not been explicitly planned a priori.

For example, a blizzard can cause major disruption in a region's transportation networks, closing down subways and trains, slowing car traffic, and cancelling flights; also affecting other systems such as the power grid. Currently, city planners use prior experiences to prepare for a blizzard by pre-locating assets such as snow plows and salt to clear the roads. National Guard and State Troopers are dispatched in patrols for rescue missions and to prevent crime. Shelters are established and evacuation recommendations are communicated to the community. During and after the blizzard, city planners use various ad-hoc information feedback loops to manage the assets. Unfortunately, city planners must improvise before, during, and after a natural disaster without design tools.

Recently, cities in the United States are making urban infrastructure data accessible to developers and providing development frameworks for the community to create useful applications (e.g., tracking snow plows in real-time). While these initiatives and similar services are a step forward, the available data sets are based on historical data and can only reflect known events. Therefore, existing tools are restricted to designing alternative urban configurations against playbook scenarios. These tools are limited to designs for system resilience, defined as the use of existing capabilities—the interplay between functions, behaviors, and structures—against predetermined scenarios to provide functional continuity and risk management; these are primarily used for planning in pre-event and disaster stages.

Accordingly, it is desired to create a framework for analyzing complex system-of-systems that offers the capability of adaptive resilience, thereby providing a more robust, consistent, and reliable understanding of how to optimally use system resources.

### SUMMARY

Embodiments of the present invention address and overcome one or more of the above shortcomings and drawbacks, by providing methods, systems, and apparatuses related to a complex system-of-systems for planning and adaptation to unplanned scenarios. These techniques and technologies are capable of fully considering the various interdependencies of heterogeneous systems, over space and time, and the consequent emergent behaviors.

According to some embodiments, a computer-implemented method for providing adaptive resilience to a system defined by a plurality of physical components includes generating an ontology comprising a plurality of objects. Each object corresponds to (i) functions performed by a discrete physical component of the system; (ii) behaviors of the discrete physical component; (iii) physical structures included in the discrete physical component; and (iv) events that impact usage of the discrete physical component. Relationships are added to the ontology for each of the plurality of physical components. The relationships comprise (i) aggregation relationships between the plurality of physical components, (ii) composition relationships between the plurality of physical components; and (iii) dependencies between the plurality of physical components. Sensor data is received from one or more sensors monitoring activities associated with the plurality of physical components included in the system. Based on the sensor data, an event is identified that is impacting one or more physical components performing a system function. Next, the attributes and the relationships stored in the ontology are used to generate an alternate system design comprising physical components that are functionally equivalent to the impacted physical components with respect to the system function. Then, a transmittal comprising the alternate system design is sent to one or more users.

Some embodiments of the aforementioned method further include using the objects and relationships stored in the ontology to generate one or more instructions for repurposing physical components included in the system to implement the alternate system design.

Various techniques may be used for updating the ontology in the aforementioned method. For example, in some embodiments, new relationships between objects in the ontology corresponding to the alternate system design are identified and used to update the ontology. In other embodiments, new objects corresponding to physical components included the alternate system design. These new objects comprise one or more (i) new functions performed by the physical components in the alternate system design; (ii) new behaviors of the physical components; (iii) new physical structures constructed based on the physical components in the alternate system design; (iv) new constraints related to usage of the physical components in the alternate system design. The ontology may then be updated with the new objects.

In some embodiments of the aforementioned method, the alternate system design is generated by creating a plurality of possible alternate system designs using the attributes and relationships stored in the ontology and simulating the impacted system function with each of the plurality of possible alternate system designs to yield simulation results. Based on the simulation results, one of the possible alternate system designs is selected as the alternate system design. In one embodiment, the impacted system function is simulated using a system of simulations executing across a parallel computing architecture. This system of simulations may be created, for example, by automatically combining a plurality of simulation models according to predetermined rules.

In some embodiments of the aforementioned method, the alternate system design is selected from the possible alternate system designs by ranking the possible alternate system designs according to one or more pre-determined criteria, and selecting a highest ranking possible alternate system design as the alternate system design. The pre-determined criteria may include, for example, a measurement of distance between objects included in each possible alternate design and the event impacting the objects performing the system function, a measurement of monetary cost associated with implementing each possible alternate design, or a measurement of power consumption of each design.

According to another aspect of the present invention, a second computer-implemented method for providing adaptive resilience to a physical system comprising a plurality of objects includes generating a graph representative of objects included in a system. The graph comprises a plurality of nodes, wherein each node is a programming component representing one or more of (i) a function performed by a discrete object included in the system; (ii) behaviors of the discrete object; (iii) a physical structure included in the discrete object; and (iv) an event that impacts usage of the discrete object. The edges between the nodes correspond to relationships between the objects of the system, wherein the relationships comprise (i) aggregation relationships between the plurality of objects, (ii) composition relationships between the plurality of objects; and (iii) dependencies between the plurality of objects. Sensor data is received from one or more sensors monitoring activities associated with physical structures included in the system. Based on the sensor data, an event is identified that is impacting one or more objects performing a system function. The graph is used to generate an alternate system design which comprises a plurality of objects that are functionally equivalent to the impacted objects with respect to the system function. Then, a transmittal comprising the alternate system design is sent to one or more users.

In some embodiments of the second method discussed above, the edges included in the graph are used to generate one or more instructions for repurposing physical objects included in the system to implement the alternate system design. Similarly, new relationships between objects included in the alternate system design may be identified and used to update the graph with new edges. Additionally, the characteristics of the objects included in the alternate system design may be used to update the graph with one or more nodes representative of the characteristics.

In some embodiments of the aforementioned second method, the alternate system design is generated by creating a plurality of possible alternate system designs via traversal of the graph starting at nodes corresponding to the impacted objects. The impacted system function is simulated with each of the plurality of possible alternate system designs to yield simulation results. Then, based on the simulation results, selecting one of the possible alternate system designs is selected as the alternate system design.

According to another aspect of the present invention, a system for providing adaptive resilience to a physical system includes a non-transitory computer reasonable readable medium storing a graph representative of objects included in a system, a plurality of device processors, and a host processor. The graph comprises a plurality of nodes and edges. Each node is a programming component representing one or more of (i) a function performed by a discrete object included in the system; (ii) behaviors of the discrete object; (ii) a physical structure included in the discrete object; (iii) an event that impacts usage of the discrete object. The edges between the plurality of nodes correspond to relationships between the objects of the system, wherein the relationships comprise (i) aggregation relationships between the plurality of objects, (ii) composition relationships between the plurality of objects; and (iii) dependencies between the plurality of objects. The host processor is configured to receive sensor data from one or more sensors monitoring activities associated with physical structures included in the system. Based on the sensor data, the host processor identifies an event impacting one or more objects performing a system function. The host processor creates a plurality of possible alternate system designs by traversing the graph starting at nodes corresponding to the impacted objects. Next, the host processor uses the device processors to simulate the impacted system function with each of the plurality of possible alternate system designs in parallel to yield simulation results. Then, based on the simulation results, one of the possible alternate system designs are selected as an optimal alternate system design.

Additional features and advantages of the invention will be made apparent from the following detailed description of illustrative embodiments that proceeds with reference to the accompanying drawings.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 provide a high-level overview of a SoS to which the techniques described herein may be applied;

FIG. 2 provides a conceptual diagram which illustrates the units of composition and knowledge representation (UCKR) data model, as it may be implemented in some embodiments;

FIG. 3A illustrates examples of the type of information that can be used in defining structures, behaviors, functional, constraints, and events associated with UCKRs in a healthcare setting;

FIG. 3B provides further detail of how the structures specified in UCKRs may be refined in some embodiments;

FIG. 3C provides further detail of how the functions specified in UCKRs may be refined in some embodiments;

FIG. 3D provides further detail of how the models used by UCKRs may be refined in some embodiments;

FIG. 3D provides further detail of how the events specified in UCKRs may be refined in some embodiments;

FIG. 4 provides a conceptual overview of how UCKRs can be used to provide adaptive resilience to a system, according to some embodiments.

FIG. 5 shows the software architecture for designing a complex system-of-systems for planning and adaptation to unplanned scenarios, according to some embodiments of the present invention;

FIG. 6 provides example of a graphical user interface, as it may be configured and arranged in some embodiments;

FIG. 7 illustrates an example of a simulation network, as it may be implemented in some embodiments;

FIG. 8 provides an example of offline tool configuration method that may be implemented by the software architecture, according to some embodiments;

FIG. 9 presents an example of three use cases focusing on resilience, adaptation, living systems related issues, respectively, that may be used in accordance with some embodiments;

FIG. 10 illustrates an online adaption workflow that may be used in some embodiments of the present invention; and

FIG. 11 provides an example of a parallel processing memory architecture that may be utilized to perform computations related to execution of the various workflows and architectures discussed herein, according to some embodiments of the present invention.

### DETAILED DESCRIPTION

The following disclosure describes the present invention according to several embodiments directed at methods, systems, and apparatuses related to designing a complex system-of-systems for planning and adaptation to unplanned scenarios. Briefly, the techniques described herein utilize a dashboard that can be used to both plan a system-of-systems (SoS), for improved resiliency with respect to SoS designed with standard tools, (“planning mode”) and to adapt an existing SoS to unplanned needs and configurations (“adaptation mode”). Such dashboard will take as input information on the known resources and behaviors in the considered SoS, on the known functions the SoS can perform in normal conditions and on the constraints that exist. In planning mode, this information will reflect the design space, which the user is willing to explore. In adaptation mode, this information will reflect the characteristics of the existing system, under normal operations (i.e. not under the emergency scenario). The techniques described herein are generally applicable to any complex system including, for example, urban infrastructure, manufacturing plants, product life cycles, and robotics.

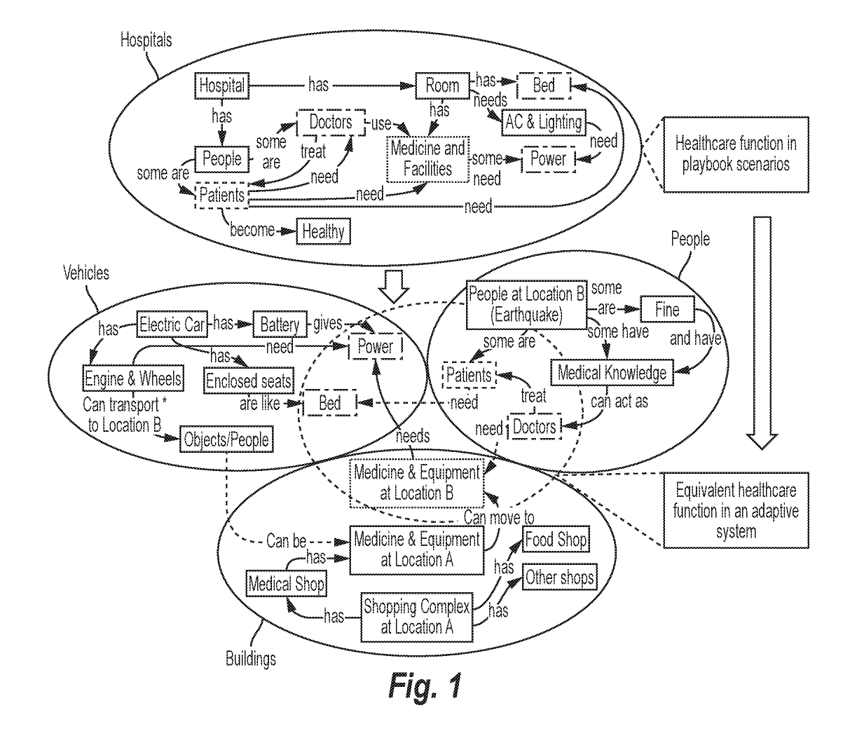

FIG. 1 provides a high-level overview of a SoS to which the techniques described herein may be applied. The term SoS refers to a complex system which combines the resources, capabilities, and overall function of a plurality of task-oriented or dedicated systems. The example presented in FIG. 1 corresponds to a SoS for healthcare-related functions. Using the tools discussed herein, the SoS presented in FIG. 1 may be analyzed to identify specific configurations of the constituent systems that are able to be readily adapted to unplanned needs that may exist under normal operation conditions and emergency scenarios.

In FIG. 1, there are three constituent systems: vehicles, people, and buildings. Each system is defined by a set of resources and relationships between those resources. Thus, for example, in the vehicle system, an electric car resource comprises battery, enclosed seats, engine, and wheel resources. In some embodiments, each constituent system may have one or more sensors that provide information on the current state of its resources. By combining the three constituent systems, a SoS can be created as shown by the dotted line in FIG. 1. In this example, the three constituent systems are combined in a manner that provides healthcare functions that would ordinarily be provided by a hospital system (shown in the top portion of FIG. 1). For example, the hospital subsystem includes power and bed resources. These can be provided to the SoS using the power provided by the electric car's battery and the enclosed seats, respectively.

Functional composition has advantages over conventional design tools that use incompatible system models that are discipline or domain-dependent and not inter-operable. To date, the automatic composition of functionally equivalent function-behavior-structures of complex cyber-physical systems using functional abstractions have been demonstrated in some limited scenarios. However, several key challenges remain in demonstrating the viability of a design tool for adaptive resilience of Systems-of-Systems (SoS) including: (1) “zooming” across multiple space-time scales, hierarchies, and interactions; (2) identifying, on-the-fly, the need of specific functions based on a diagnosis of the state of the system; and (3) developing a System of Simulations (SySim) that does not rely on oversimplifications. The techniques described herein address these challenges by: (1) unifying function-behavior-structure-constraints-events in core units of composition and knowledge representation (UCKR) that can be transacted over in multiple scales of space and time; (2) developing a self-diagnosis capability by continuously monitoring the environmental state with sensors; (3) engineering a flexible and scalable architecture for the adaptive simulation of heterogeneous multi-fidelity models through reconfiguration and recalibration.

UCKRs allow one to develop urban infrastructure models at different fidelity levels, and define an interface with external systems. As an example of the utility of UCKRs, several scenarios are discussed herein which focus on redesigning an urban infrastructure in case of unexpected events such as an earthquake and further cascading events leading to power blackouts and fires. More specifically, the discussion presented herein focuses on the function of health care in such scenarios. As shown in FIG. 1, the goal is to restore the healthcare function during an earthquake, through improvisation and adaptation, with the objective of optimizing performance metrics (e.g. no. of lives saved, cost, resilience, etc.). In short, UCKRs allow one to find functional equivalences between unexpected resources and adapting them for some use other than for which they were designed for.

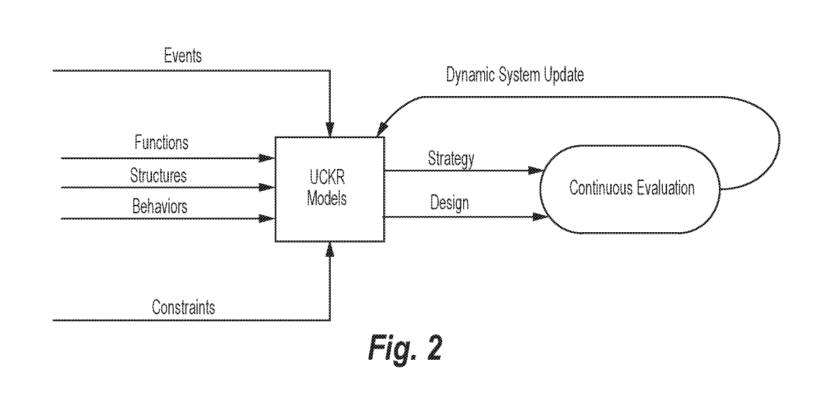

FIG. 2 provides a conceptual diagram which illustrates the UCKR data model, as it may be implemented in some embodiments. A UCKR formally describes a system's function, behavior, structure, constraints, and events. A set of UCKRs can form a higher-level UCKR. For example, “engine”, “wheel”, “chassis” units may form a “car” unit; and multiple “car”, “train”, and “bicycle” units may form a “vehicle” unit. In some embodiments, each UCKR is implemented as a mathematical function that receives functions, behavior, structures, constraints, and events as inputs, and computes a strategy-design pair to achieve a goal. A plan is the set of actions to be performed by the system to achieve the goal; and a design is the re-composition of the system's function, behavior, structure, constraints, and events.

Strategy-design pairs may be used to dynamically update the system through a continuous evaluation over time. A notional functional equivalence algorithm can be implemented as a four step process: (1) searching in unit hierarchies by traversing the function, behavior, structure, constraints, and events associated with the unit; (2) composing behaviors, structures, constraints, and events (plain-design pairs) that are functionally equivalent to the missing function; (3) evaluating the candidate strategy-design pairs and ranking according to a given criteria; and (4) creating new units, at multiple levels of abstraction, to express the newly discovered knowledge.

A key innovation in UCKRs is their organization. Rather than relying in a monolithic data structure, the focus is on the relationships between units. For example in some embodiments, units form a directed graph where nodes represent units and edges represent transformations between units. These transformations represent relationships such as aggregation, composition, composability, and dependencies. This representation provides the flexibility to use the models associated to the different nodes “as-is” (e.g., for parsing, evaluation, simulation), and the information associated to the edges to discover and create new knowledge. The unit graph is dynamic in the sense that data, queries, simulation, and models are continuously modifying the graph with new nodes and edges. Even though this may result in a large graph with billions of nodes and edges, existing databases (e.g., Linked Data) and algorithms (e.g. Pregel, MapReduce) running in cloud platforms can help to efficiently search and update the graph. As an alternative to a graph, in some embodiments, the UCKRs are stored as an ontology expressed in a language such as expressed the Web Ontology Language (OWL).

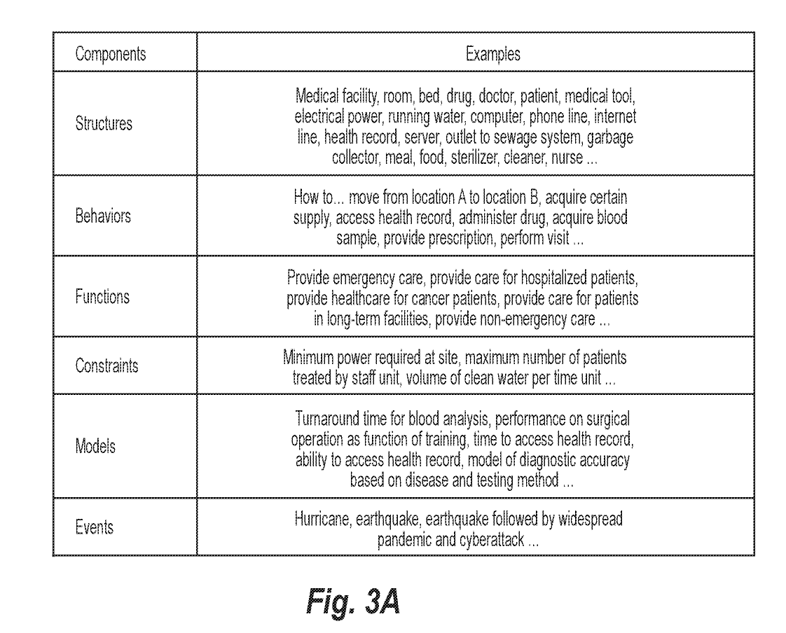

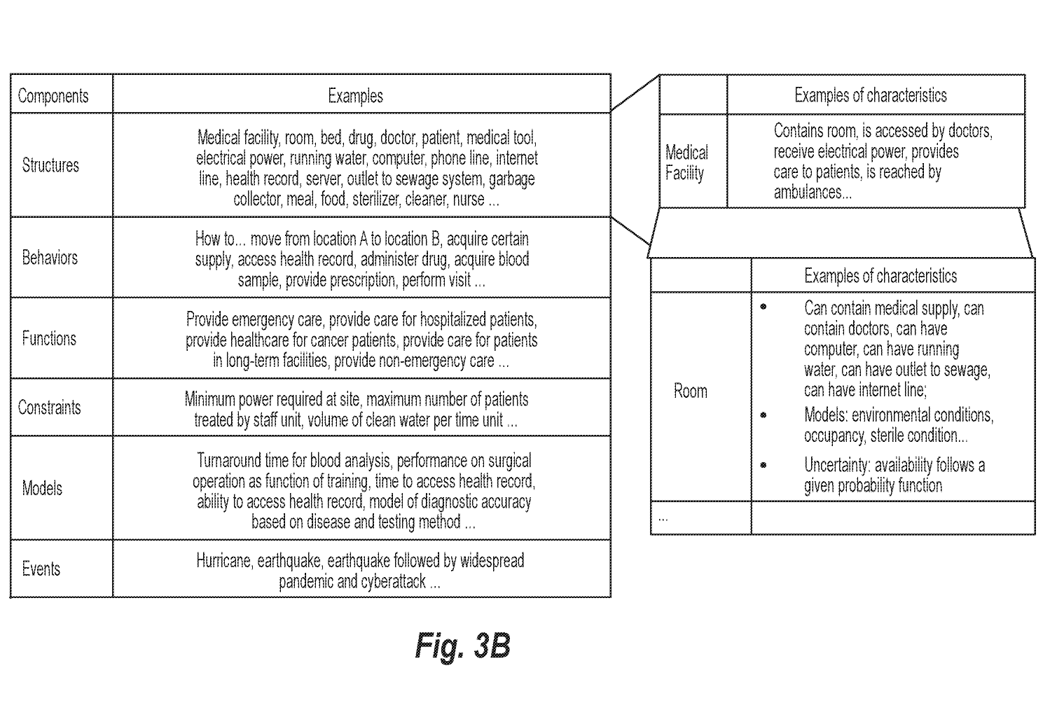

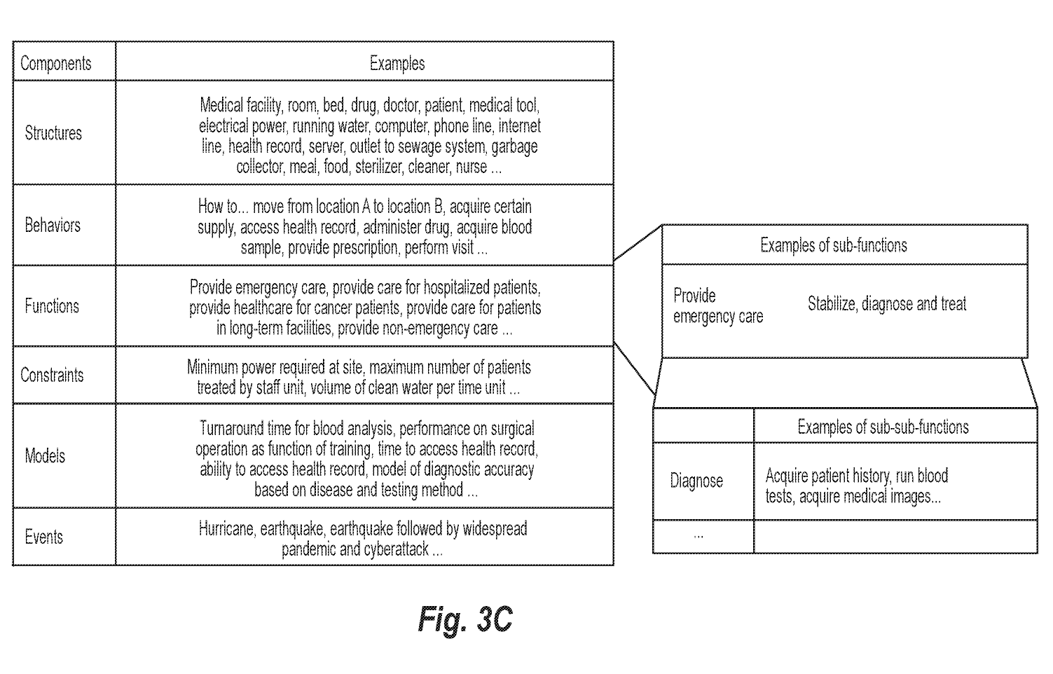

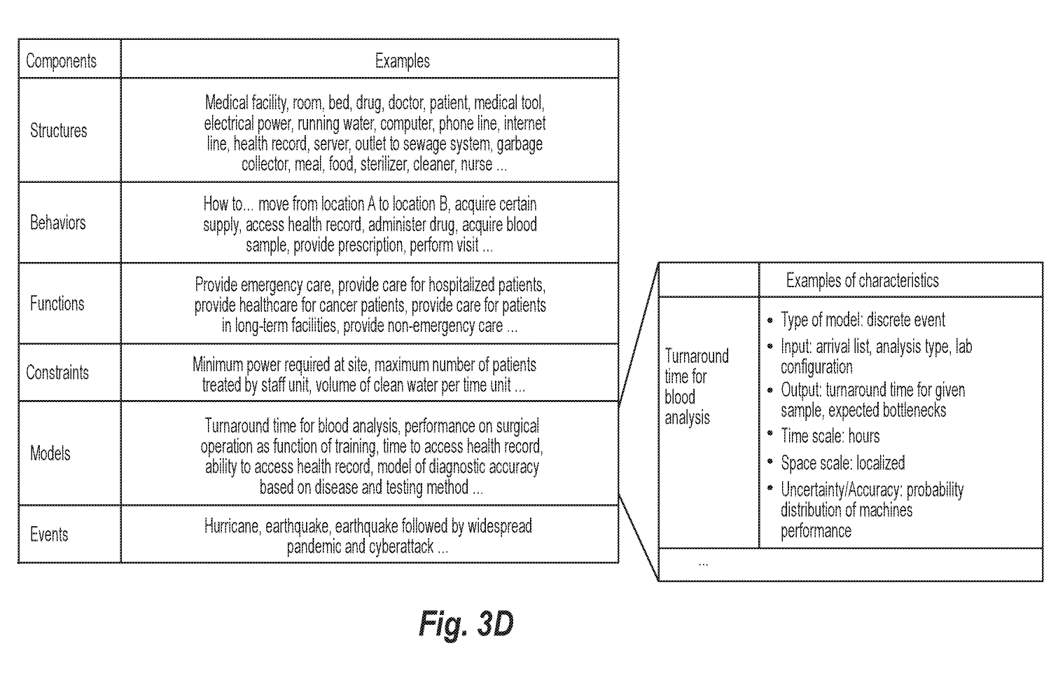

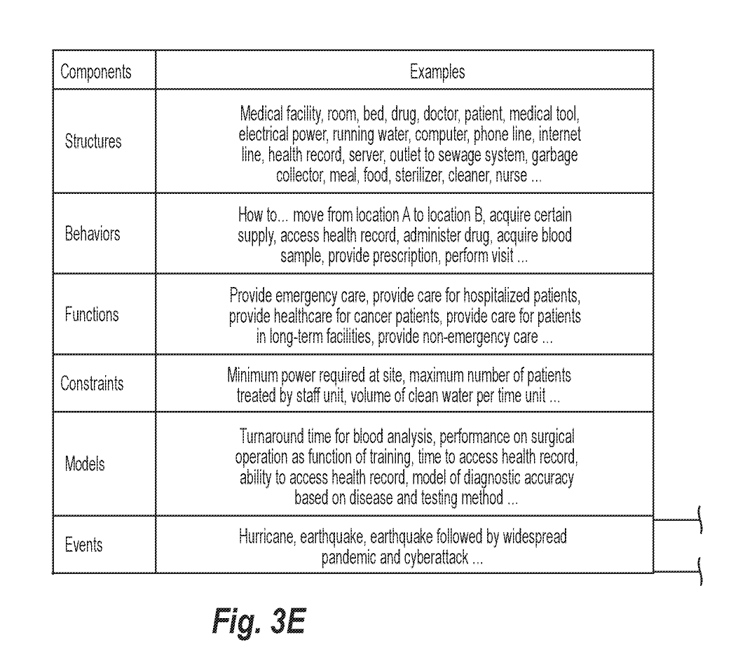

FIGS. 3A-3E show examples of the type information captured in UCKRs, according to some embodiments. FIG. 3A illustrates some examples of the type of information that can be used in defining structures, behaviors, functions, constraints, and events associated with UCKRs in a healthcare setting. FIG. 3A further includes models that may be included in the UCKRs. FIGS. 3B-3E provide further detail of how the structures, functions, models, and events, respectively, may be refined in some embodiments.

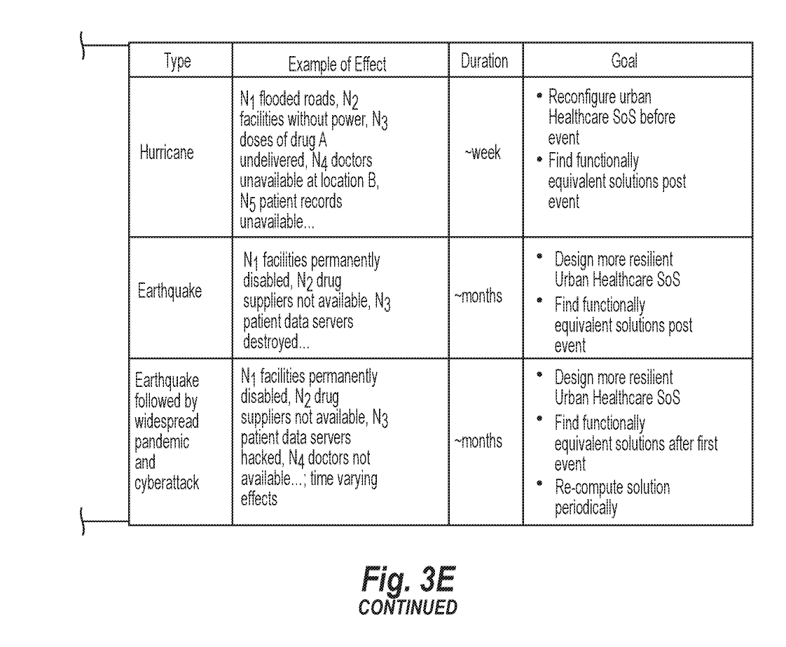

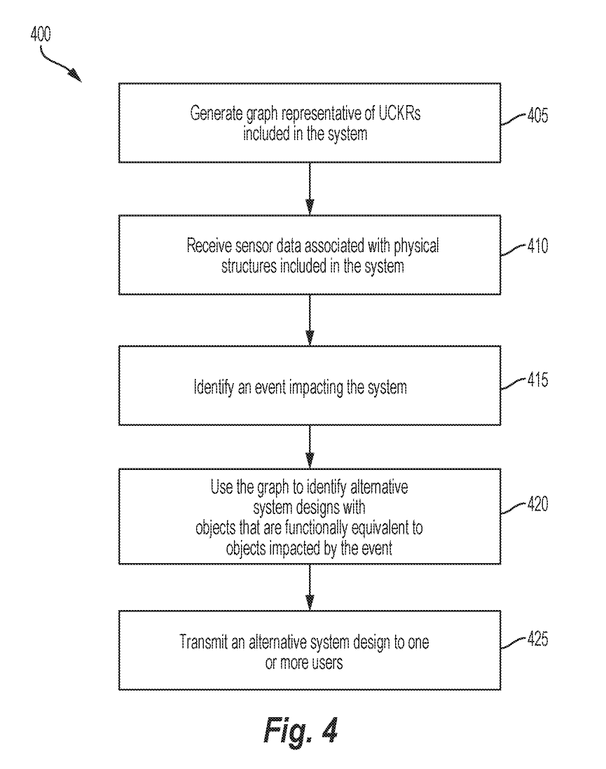

FIG. 4 provides a conceptual overview of how UCKRs can be used to provide adaptive resilience to a system, according to some embodiments. Starting at step 405, a graph is generated which is representative of UCKR objects included in the system. The graph includes nodes which corresponding to functions performed by objects included in the system; behaviors of the objects; physical structures included in objects; constraints related to usage of the objects; and events that impact usage of the objects. Each node may be represented by a programming component such as a data structure. Functions can be represented by a programming component such as a routine. The edges between the nodes correspond to relationships between the objects of the system. These relationships may include, for example aggregation relationships between the objects, composition relationships between the objects; and dependencies between the objects. The initial version of the graph may be generated manually by one or more domain experts. Alternatively (or additionally) graph information may be populated automatically by analyzing technical documentation associated with system objects, using natural language processing techniques. Once the graph is generated, it may be stored in a database or similar computer readable medium for later use.

Continuing with reference to FIG. 4, at step 410, sensor data is received from sensors monitoring activities associated with physical structures included in the system. Such data may include, for example, pressure sensors monitoring water and/or gas flow, electrical power availability, etc. At step 415, based on the sensor data, an event is identified that is impacting objects performing a system function. The term “system function” is defined herein as including any function that may be performed by objects acting alone or in combination to produce an outcome. For example, based on the sensor providing electrical power availability, the system may determine that a power outage event is impacting the use of collection of objects providing a “hospital” function.

Once the event is detected, at step 420, the graph is used to generate an alternate system design which includes comprises objects that are functionally equivalent to the impacted objects with respect to the system function. For example, if the system function is transportation and trains are the impacted objects, the functionally equivalent objects may comprise groupings of busses that offer that same transportation capacity.

In some embodiments, a series of alternate system designs are generated an evaluated. For example, in one embodiment, a plurality of possible alternate system designs are identified by traversing the graph starting at nodes corresponding to the objects impacted by the event. A simulation may be then being performed to simulate the impacted system function with each of the plurality of possible alternate system designs. Techniques for performing this simulation are described in further detail below. Based on the simulation results, one of the possible alternate system designs is selected as the alternate system design. For example, in one embodiment, the possible alternate system designs according to one or more pre-determined criteria (distance between objects, power consumption, and monetary cost to implement). Then, the highest ranking possible alternate system design may be designated the alternate system design.

Finally, at step 425, a transmittal is sent comprising the alternate system design is sent to one or more users. This transmittal can generally take any form generally known in the art for conveying information. Thus, for example, the transmittal can be a simply message displayed in a GUI which allows user interaction with the various system components. In other embodiments, the transmittal can be a message (e.g., email) sent to users via mobile devices. In this way information can be transmitted to first responders (e.g., police, fire fighters, etc.) to allow system components to be repurposed as necessary to provide the system function. In some embodiments, the transmittal includes instructions describing the strategy for repurposing the physical object to implement the alternate system design. These instructions may be derived, for example, using the information associated with the edge relationships in the graph.

It should be noted that the alternate system design can be used to update the graph as needed to capture the new knowledge embodiment in the design. For example, new edges may be added to the graph based on new relationships identified between objects included in the alternate system design. Similarly the characteristics of the objects included in the alternate system design may be used to update the graph with one or more nodes representative of the characteristics.

As an alternative to the graph implementation, a more generic ontology is used in some embodiments. This ontology includes objects corresponding to functions performed by discrete physical components of the system, behaviors of the discrete physical components, physical structures included in the discrete physical components, constraints related to usage of the discrete physical components; and events that impact usage of the discrete physical component. The ontology also captures relationships between the physical components, such as aggregation relationships between the plurality of physical components, composition relationships between the plurality of physical components, and dependencies between the pluralities of physical components. As with the graph, the ontology may be generated by a knowledge domain expert and/or through automatic techniques (e.g., analyzing technical documentation). Once generated, the ontology may be used in a manner similar to the graph as described above with reference to FIG. 4.

To identify a configuration(s) of the UCKRs suitable to meet the needs of a particular scenario (e.g., providing hospital services in the event of an earthquake as shown in FIG. 1), some of the techniques described herein utilize a simulation network comprising a plurality of simulation models. Using the network, a combined simulation may be performed to identify and evaluate potential solutions to the needs. In some embodiments, a graphical user interface (GUI) is used to present the results of this analysis and facilitate further interactions with the user.

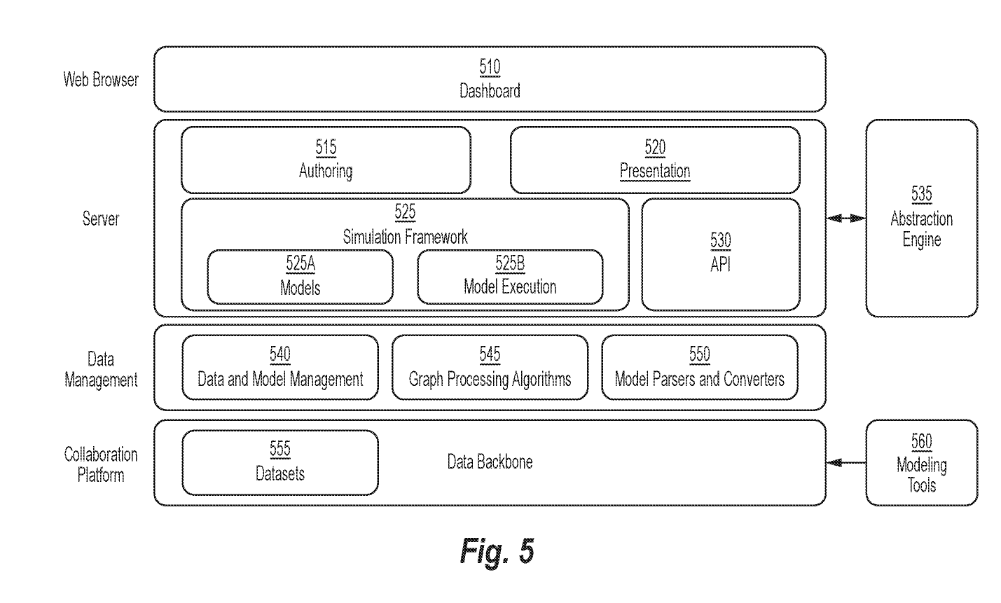

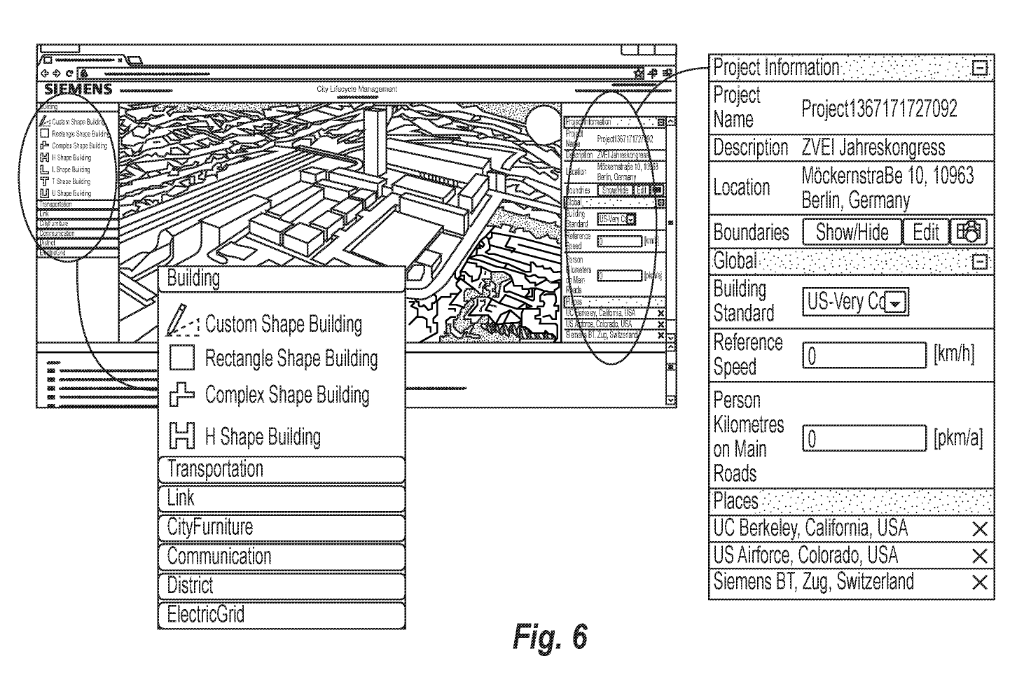

FIG. 5 shows the software architecture 500 for designing a complex system-of-systems for planning and adaptation to unplanned scenarios, according to some embodiments of the present invention. The Dashboard 510 is a web application that will be executed in the user's web browser with advanced visualization capabilities. One example of the Dashboard 510, as it may be configured and arranged in some embodiments, is shown in FIG. 6. Users may import, for example, an existing city, edit a city, select and create scenarios, select metrics, perform simulations, manage and visualize data, results, and configurations. The Server layer comprises an Authoring Module 515 for receiving these user inputs via the Dashboard 510. Similarly a Presentation Module 520 configures the presentation of output data within the Dashboard 510. Both of this Modules 515, 520 may be implemented, for example, using a specific software library, class, or other collection of suitable software functions.

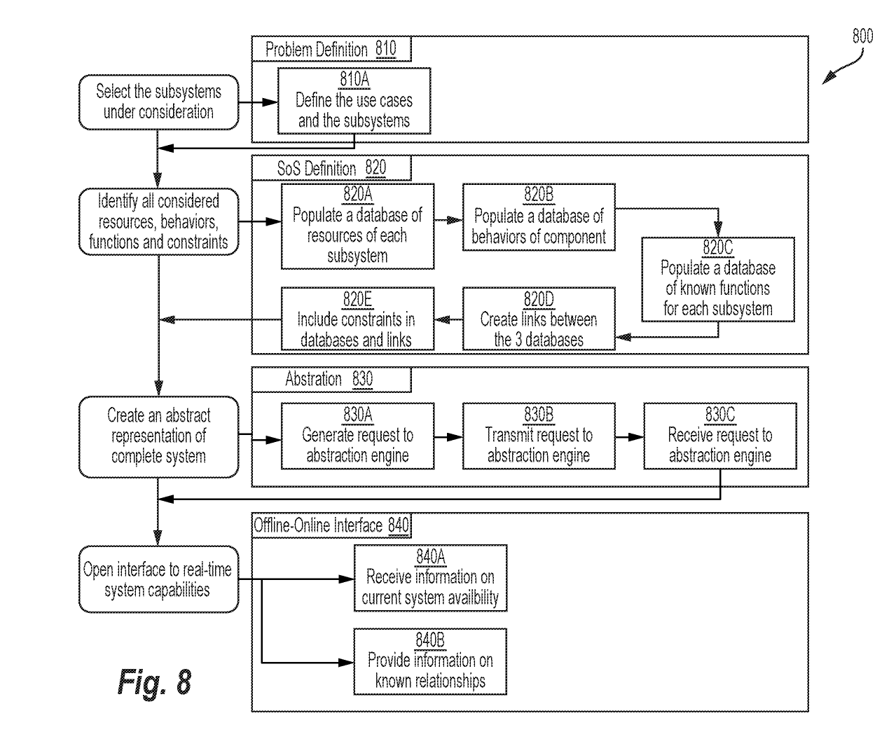

Continuing with reference to FIG. 5, a Simulation Framework 525 contains Models 525A, and a Model Execution Module 525B. Models 525A comprise a plurality of simulation models stored in a database or other storage mechanism. The Model Execution Module 525B manages the execution of the models; either on the server's computing resources or using an external computing platform. For example, as described in further detail below with respect to FIG. 8, in some embodiments, a parallel processing environment is used to execute each simulation network.

The Application Program Interface (API) 530 in the software architecture 500 is the programmatic interface to external devices. The Server interacts with the Abstraction Engine 535 which provides a list system designs comprising UCKRs (e.g., in graph or ontology form) using the techniques described above with reference to FIG. 4.

The Data Management layer contains the Data and Model Management Module 540 that combines simulation models according to predetermined rules to create simulation networks. The generation of the simulation network is driven by the set of metrics that needs to be computed and the relationships pre-defined between system components. As an example, if the time to perform a set of actions is the metric of interest, the system will look for a model for performance time in each of the components that represent the considered actions, and run these models in a sequence, provided that the actions are performed sequentially, feeding the result of the first model of action to the subsequent one. This Module 540 utilizes Graph Processing Algorithms 545 and Model Parsers and Converters 550 to facilitate generation and processing of the simulation networks. These modules identify the connections between system components in the graph that represents it, identifies the input/output variables of the models associated to them, and identify the proper conversions needed to allow interaction among the models.

The Collaboration Platform layer is the Data Backbone that contains the Datasets 555 generated using the Simulation Framework 525. External Modeling Tools 560 may be used to create and edit models in their native formats, which may then be uploaded to Simulation Framework 525 via the Data Backbone. In this way, the Simulation Framework 525 may be updated continuously with new, more up-to-date models thereby providing a more robust simulation environment.

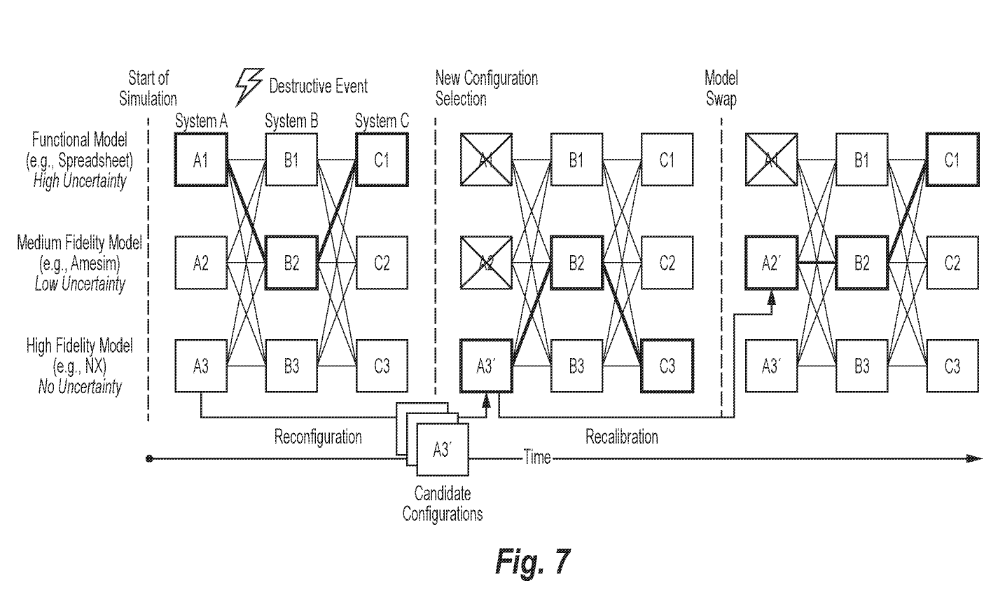

FIG. 7 illustrates an example of a simulation network, as it may be implemented in some embodiments. This example comprises three systems: vehicles (System A), roads (System B), and hospitals (System C). All models representing the systems in various fidelity levels (A1, A2, A3, B1, B2, B3, C1, C2, C3) are available in the Simulation Framework 525. Before launching the simulation, a request is sent to the Abstraction Engine 235 to obtain the composition of models necessary to evaluate the system's function (e.g., “Transport people to hospitals”). The Abstraction Engine 535 engine returns the set {A1, B2, C1} for the software architecture 200 to compose the simulation network that will be used until an event is detected. Events that cause permanent structure and behavior damage trigger a reconfiguration request to Abstraction Engine 235 to find alternative system designs and configurations through functional equivalence; and non-destructive events might be able to reuse the existing simulation if only constraints are affected.

Continuing with reference to FIG. 7, one concrete reconfiguration example is the use of 3D geometric models of a car and a paddle boat to synthesize a makeshift “speedboat” represented by A3′. When a new configuration is selected, after evaluating the candidate configurations, the server in the software architecture 500 pushes a new request to Abstraction Engine 235 to obtain a new composition of models necessary to assess the system's function. This is necessary because the original medium fidelity and functional models A1 and A2 are no longer valid because they do not accurately represent the function, behavior, structures, constraints and events of the new “speedboat” A3′. In this example, the new set is {A3′, B2, C3} and it can be used until a new event is detected, or until simulation recalibration is completed. Recalibration is important because simpler and less computationally expensive models can be reused after the key performance characteristics are obtained from the high fidelity models. When recalibration succeeds, the software architecture 200 may perform a model swap, e.g., from A3′ to A2′. Model swaps push a request to the Abstraction Engine 535 to obtain a new set (e.g., {A2′, B2, C1}). In some embodiments, the simulation network will be continuously evaluating the state of the system, reconfiguring, recalibrating, and swapping models, multiple systems at a time.

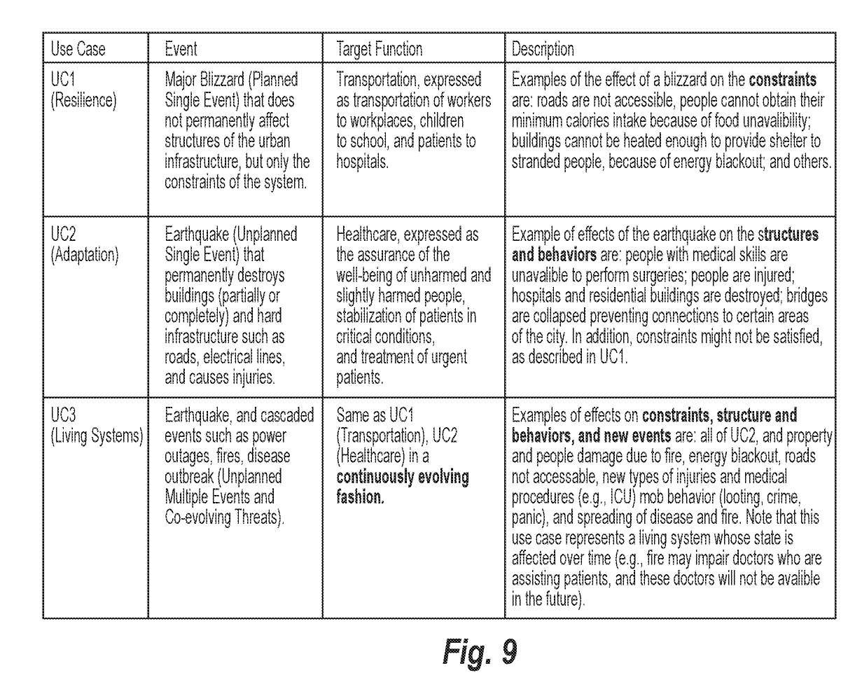

FIG. 8 provides an example of offline tool configuration method 800 that may be implemented by the software architecture 200, according to some embodiments. The method 800 begins at step 805 where the subsystems under consideration are identified, for example, based on user input. Based on the identified subsystems, the Problem Definition Phase 810 is started during which, at step 810A, the relevant use cases and the details of the subsystem are defined. FIG. 9 presents an example of three use cases focusing on resilience, adaptation, living systems related issues, respectively.

During the Problem Definition Phase, the considered resources, behaviors, functions and constraints of the subsystems under consideration are identified during a “SoS Definition” Phase 820. Three databases are created during this Phase 820, including a database of resources for each subsystem, a database of behaviors for each component, and a database of known functions for each subsystem. Such databases can be populated manually by a subject matter expert, or by browsing existing domain-specific databases, or potentially by automatically analyze literature on the specific problem, using natural language processing techniques. Next at step 820D, links are created between the three databases populated at steps 820A-820C. An example for such creation is the following: if function A can be performed by object B while it exhibits behavior C consuming resource D, links will be created between A to B, C to B and D. Then, at step 820E, constraints are applied to the databases populated at steps 820A-820C and the links created at step 820D. Constraints can be associated to behaviors. For example, a car can move from location x to location y only if it has enough fuel. Hence, the behavior of moving a car from x to y will happen only after the constraint on fuel has been met. Constraints can be created similarly to how the databases in Phase 820 are created.

Continuing with reference to FIG. 8, an abstract representation of the complete system is generated with an abstraction engine during the Abstraction Phase 830. At step 830A-830B, a request is generated to an abstraction engine. As discussed above, the abstraction engine is a connected software tool that provides a mathematical representation for the system using various models (e.g., low-fidelity, medium-fidelity, high-fidelity, mechanical, electrical, etc.). This abstraction engine may be internal to the system hosting the dashboard or, in some instances, an external abstraction engine may be used (e.g., hosted by another party). At step 830C, this mathematical representation is received from the abstraction engine in response to the original request.

The result of the abstract SoS representation may be queried in the Offline-Online Interface Phase 840 to identify a set of lower level functions, able to satisfy the need identified by the system. Additionally, this result may be used to identify resources and links (among the available ones) to perform a given function. Additional input is provided at run-time during the Offline-Online Interface Phase 840, when the tool is utilized to adapt the SoS to an unplanned scenario. In this case, a set of sensors (of various types), embedded in the SoS, provides data to the tool with the purpose of both identifying any unpredicted need and to assess the current status of the SoS. Thus, at step 840B, information on the current system availability is received and, at step 840B, information is provided on known system relationships.

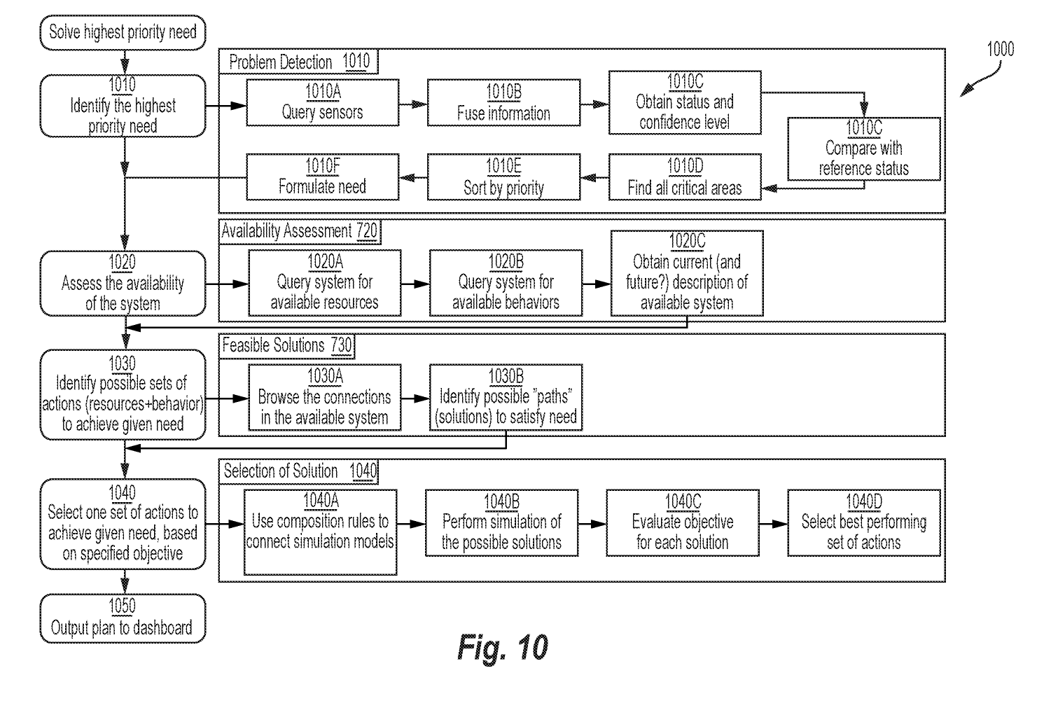

FIG. 10 illustrates an online adaption workflow 1000 that may be used in some embodiments of the present invention. In adaptation mode, the Dashboard computes and outputs to the user the set of resources and “instructions” to use in space and time to react to a detected scenario and satisfy the need(s) that is (are) identified as priority. The workflow 1000 in this case includes the following phases: a Problem Detection Phase 1010, an Availability Assessment Phase 1020, a Feasible Solutions Phase 1030, and a Selection of Solution Phase 1040.

The Problem Detection Phase 1010 is performed periodically during the operation, when new sensors information is detected, to identify the highest priority, unplanned needs of the SoS. Starting at step 1010A, the various sensors are queried to gather relevant information. These sensors may include traditional physical sensors (e.g. thermal sensors, visual sensors, etc.), as well as “soft” sensors such as communications on social networks. Next, at step 1010B, the information from the sensors is fused. This problem can be tackled, for example, using Sheaf Theory or similar technique, and will result in information on the current status of the system, equipped with the accuracy of such information, based on the accuracy of the utilized sensors and on the discrepancy among the incoming pieces of information. At step 1010C, the detected status of the system is compared with a reference (set of) status(es). These reference statuses may be specified, for example based on user and/or based on a historical analysis of the system under normal working conditions. At step 1010D, statuses that deviate from the reference values by more than some threshold amount are characterized as “critical.” Next, at step 1010E, the statuses that were identified as critical are sorted by priority. The priority list can be determined “a priori” based on general rules or knowledge (e.g. it is of higher priority to resolve safety issues than to resolve networking issues) or based on user input. Finally, at step 1010F, the system identifies a high-level function/need/mission to accomplish with the reconfiguration, basing the decision of the main mission on the priority list (e.g. mission of providing healthcare if survival of humans is the priority).

During the Availability Assessment 1020, once a new need is detected, the sensing system will be queried to identify the resources, behaviors, lower-level functions and constraints that are available or active at the present time. This assessment is performed at steps 1020A and 1020B. This information will be used to update the abstract description of the SoS (“Offline-Online Interface”) at step 1020C, before proceeding to the next phase. In addition, in some embodiments, additional information may be gathered on the predicted availability in the near future, or its uncertainty, can be added to this phase, for more robust adaptation.

The objective of the Feasible Solutions Phase 1030 is to identify, in the currently available system, solutions (in terms of usage of resources and “instructions”) that could satisfy the identified needs. Thus, at step 1030A, the connections in the available system are browsed. These connections can reside in any of the sub-systems within the SoS. Then, at step 1030B, the possible “paths” (i.e., solutions) to satisfy the need are identified. This identification can be done using graph analysis techniques.

Once a set of feasible solutions is identified, the choice among them can be driven by the use of simulation models during the Selection of Solution Phase 1040. However, given the dynamic nature of the SoS structure, existing tools will be composed on the fly based on the abstract description of the current SoS. Starting at step 1040A, composition rules are used to connect simulation models into a simulation network. The composition rules will be based on the functions and behaviors of various structures within the simulation models, inputs and outputs of models, and the levels of models fidelity. The simulation network will have the ability to propagate the uncertainty detected in the input (e.g. on the availability of resources) to the predicted outcome. Depending on the simulation models selected in the network, different objective functions (e.g. cost, time of implementation, probability of success, etc.) could be evaluated to drive the choice on the “best” among the considered solutions. Next, at step 1040B, the connected simulation models are used to perform a simulation of all possible solutions and, at step 1040C, the objective for each solution is evaluated. Based on this evaluation, the best performing set of actions is selected at step 1040D.

As outcome of this process, at 1050, the dashboard may output a set of resources, behaviors and links among them that can be employed to satisfy the automatically identified unplanned need.

In some embodiments of the planning mode, the dashboard will output the resources and functionalities that the SoS needs to include to achieve a high level of resilience (according to a metric defined below). This will be achieved by utilizing a modified version of the workflow described above with respect to FIG. 10 for the adaptation mode. First, the Problem Detection Phase 1010 and Availability Assessment Phase 1020 are substituted by a Problem Generation Phase, where perturbation on the abstract SoS are generated either randomly or using prior information on the probability of failure/unavailability of resources (and their behaviors) and links between them. The Selection of Solution Phase 1040 is modified by substituting the task “Select best performing set of actions” (i.e., step 1040D) with “Count the number of solutions that satisfy a minimum threshold on the selected objective”. This number will be considered as proxy for a resiliency metric. This modified workflow may be repeated for several possible input configurations of the SoS (set in the offline tool configuration) and these input configurations will be ranked based on the number of acceptable solutions under the considered simulated problems. The input configuration with the highest count of acceptable solutions will be selected as the most resilient.

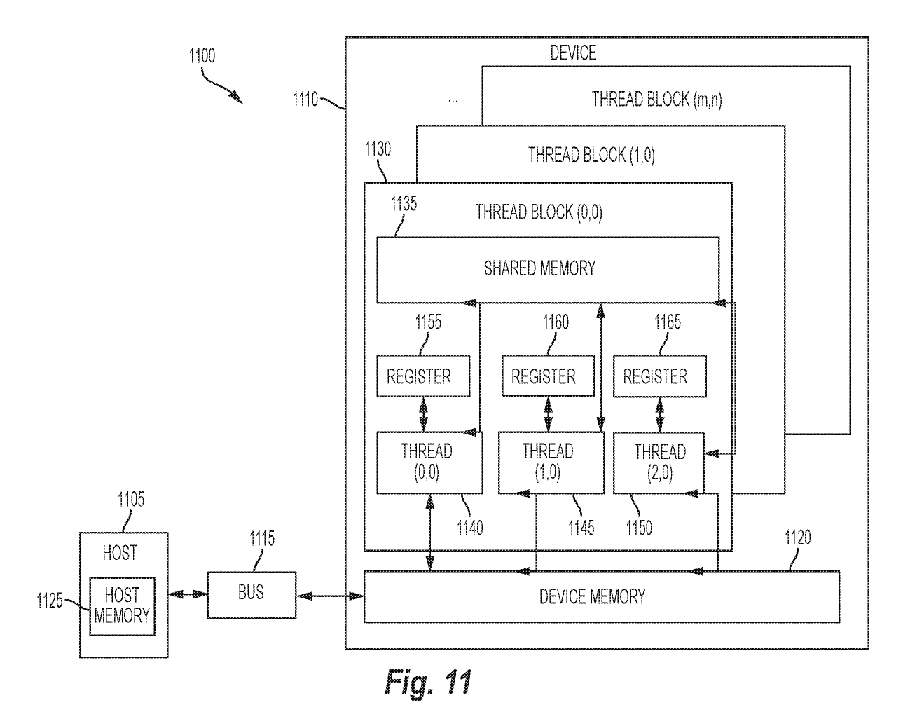

FIG. 11 provides an example of a parallel processing memory architecture 1100 that may be utilized to perform computations related to execution of the various workflows and architectures discussed herein, according to some embodiments of the present invention. This architecture 1100 may be used in embodiments of the present invention where NVIDIA™ CUDA (or a similar parallel computing platform) is used. The architecture includes a host computing unit (“host”) 1105 and a graphics processing unit (GPU) device (“device”) 1110 connected via a bus 1115 (e.g., a PCIe bus). The host 1105 includes the central processing unit, or “CPU” (not shown in FIG. 11), and host memory 1125 accessible to the CPU. The device 1110 includes the graphics processing unit (GPU) and its associated memory 1120, referred to herein as device memory. The device memory 1120 may include various types of memory, each optimized for different memory usages. For example, in some embodiments, the device memory includes global memory, constant memory, and texture memory.

Parallel portions of a deep learning application may be executed on the architecture 1100 as “device kernels” or simply “kernels.” A kernel comprises parameterized code configured to perform a particular function. The parallel computing platform is configured to execute these kernels in an optimal manner across the architecture 1100 based on parameters, settings, and other selections provided by the user. Additionally, in some embodiments, the parallel computing platform may include additional functionality to allow for automatic processing of kernels in an optimal manner with minimal input provided by the user.

The processing required for each kernel is performed by grid of thread blocks (described in greater detail below). Using concurrent kernel execution, streams, and synchronization with lightweight events, the architecture 1100 of FIG. 11 (or similar architectures) may be used to parallelize training of a deep neural network. For example, in some embodiments, the operations of the simulation platform may be partitioned such that multiple kernels execute simulate different configurations simultaneously (e.g., different viewpoints, lighting, textures, materials, effects, etc.). In other embodiments, the simulation network itself may be implemented such that various operations performed with the creation, training, and use of the network are done in parallel.

The device 1110 includes one or more thread blocks 1130 which represent the computation unit of the device 1110. The term thread block refers to a group of threads that can cooperate via shared memory and synchronize their execution to coordinate memory accesses. For example, in FIG. 11, threads 1140, 1145 and 1150 operate in thread block 1130 and access shared memory 1135. Depending on the parallel computing platform used, thread blocks may be organized in a grid structure. A computation or series of computations may then be mapped onto this grid. For example, in embodiments utilizing CUDA, computations may be mapped on one-, two-, or three-dimensional grids. Each grid contains multiple thread blocks, and each thread block contains multiple threads. For example, in FIG. 11, the thread blocks 1130 are organized in a two dimensional grid structure with m+1 rows and n+1 columns. Generally, threads in different thread blocks of the same grid cannot communicate or synchronize with each other. However, thread blocks in the same grid can run on the same multiprocessor within the GPU at the same time. The number of threads in each thread block may be limited by hardware or software constraints. To address this limitation, workflow operations may be configured in various manners to optimize use of the parallel computing platform. For example, in some embodiments, various components of the simulation network may be performed in parallel. In one embodiment, multiple simulation models included in the network are executed in parallel. In other embodiments, the simulation network can evaluate multiple configurations in parallel, thus reducing the overall time for planning and/or adaptation.

Continuing with reference to FIG. 11, registers 1155, 1160, and 1165 represent the fast memory available to thread block 1130. Each register is only accessible by a single thread. Thus, for example, register 1155 may only be accessed by thread 1140. Conversely, shared memory is allocated per thread block, so all threads in the block have access to the same shared memory. Thus, shared memory 1135 is designed to be accessed, in parallel, by each thread 1140, 1145, and 1150 in thread block 1130. Threads can access data in shared memory 1135 loaded from device memory 1120 by other threads within the same thread block (e.g., thread block 1130). The device memory 1120 is accessed by all blocks of the grid and may be implemented using, for example, Dynamic Random-Access Memory (DRAM).

Each thread can have one or more levels of memory access. For example, in the architecture 1100 of FIG. 11, each thread may have three levels of memory access. First, each thread 1140, 1145, 1150, can read and write to its corresponding registers 1155, 1160, and 1165. Registers provide the fastest memory access to threads because there are no synchronization issues and the register is generally located close to a multiprocessor executing the thread. Second, each thread 1140, 1145, 1150 in thread block 1130, may read and write data to the shared memory 1135 corresponding to that block 1130. Generally, the time required for a thread to access shared memory exceeds that of register access due to the need to synchronize access among all the threads in the thread block. However, like the registers in the thread block, the shared memory is typically located close to the multiprocessor executing the threads. The third level of memory access allows all threads on the device 1110 to read and/or write to the device memory. Device memory requires the longest time to access because access must be synchronized across the thread blocks operating on the device. Thus, in some embodiments, the processing of each simulation network is coded such that it primarily utilizes registers and shared memory and only utilizes device memory as necessary to move data in and out of a thread block.

The embodiments of the present disclosure may be implemented with any combination of hardware and software. For example, aside from parallel processing architecture presented in FIG. 11, standard computing platforms (e.g., servers, desktop computer, etc.) may be specially configured to perform the techniques discussed herein. In addition, the embodiments of the present disclosure may be included in an article of manufacture (e.g., one or more computer program products) having, for example, computer-readable, non-transitory media. The media may have embodied therein computer readable program code for providing and facilitating the mechanisms of the embodiments of the present disclosure. The article of manufacture can be included as part of a computer system or sold separately.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters.

A graphical user interface (GUI), as used herein, comprises one or more display images, generated by a display processor and enabling user interaction with a processor or other device and associated data acquisition and processing functions. The GUI also includes an executable procedure or executable application. The executable procedure or executable application conditions the display processor to generate signals representing the GUI display images. These signals are supplied to a display device which displays the image for viewing by the user. The processor, under control of an executable procedure or executable application, manipulates the GUI display images in response to signals received from the input devices. In this way, the user may interact with the display image using the input devices, enabling user interaction with the processor or other device.

The functions and process steps herein may be performed automatically or wholly or partially in response to user command. An activity (including a step) performed automatically is performed in response to one or more executable instructions or device operation without user direct initiation of the activity.

The system and processes of the figures are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. As described herein, the various systems, subsystems, agents, managers and processes can be implemented using hardware components, software components, and/or combinations thereof. No claim element herein is to be construed under the provisions of 35 U.S.C. 112, sixth paragraph, unless the element is expressly recited using the phrase “means for.”

We claim:

1. A computer-implemented method for providing adaptive resilience to a system defined by a plurality of physical components, the method comprising:
generating an ontology comprising a plurality of objects, each object corresponding to (i) functions performed by a discrete physical component of the system; (ii) behaviors of the discrete physical component; (iii) physical structures included in the discrete physical component; and (iv) events that impact usage of the discrete physical component;
adding relationships to the ontology for each of the plurality of physical components, wherein the relationships comprise (i) aggregation relationships between the plurality of physical components, (ii) composition relationships between the plurality of physical components; and (iii) dependencies between the plurality of physical components;
receiving sensor data from one or more sensors monitoring activities associated with the plurality of physical components included in the system;
based on the sensor data, identifying an event impacting one or more physical components performing a system function;
using the attributes and the relationships stored in the ontology to generate an alternate system design comprising physical components that are functionally equivalent to the impacted physical components with respect to the system function; and
sending a transmittal comprising the alternate system design to one or more users.

2. The method of claim 1, further comprising:
using the objects and relationships stored in the ontology to generate one or more instructions for repurposing physical components included in the system to implement the alternate system design.

3. The method of claim 1, further comprising:
identifying new relationships between objects in the ontology corresponding to the alternate system design; and
updating the ontology with the new relationships.

4. The method of claim 1, further comprising:
identifying one or more new objects corresponding to physical components included the alternate system design, wherein the new objects comprise one or more (i) new functions performed by the physical components in the alternate system design; (ii) new behaviors of the physical components; (iii) new physical structures constructed based on the physical components in the alternate system design; (iv) new constraints related to usage of the physical components in the alternate system design;
updating the ontology with the new objects.

5. The method of claim 1, wherein the alternate system design is generated by a process comprising:
creating a plurality of possible alternate system designs using the attributes and relationships stored in the ontology;
simulating the impacted system function with each of the plurality of possible alternate system designs to yield simulation results; and
based on the simulation results, selecting one of the possible alternate system designs as the alternate system design.

6. The method of claim 5, wherein the impacted system function is simulated using a system of simulations executing across a parallel computing architecture.

7. The method of claim 6, further comprising:
automatically combining a plurality of simulation models according to predetermined rules to create the system of simulations.

8. The method of claim 5, wherein the alternate system design is selected from the possible alternate system designs by:
ranking the possible alternate system designs according to one or more pre-determined criteria; and
selecting a highest ranking possible alternate system design as the alternate system design.

9. The method of claim 8, wherein the pre-determined criteria include a measurement of distance between objects included in each possible alternate design and the event impacting the objects performing the system function.

10. The method of claim 8, wherein the pre-determined criteria include a measurement of monetary cost associated with implementing each possible alternate design.

11. A computer-implemented method for providing adaptive resilience to a physical system comprising a plurality of objects, the method comprising:
generating a graph representative of objects included in a system, wherein the graph comprises:
a plurality of nodes, wherein each node is a programming component representing one or more of (i) a function performed by a discrete object included in the system; (ii) behaviors of the discrete object; (iii) a physical structure included in the discrete object; and (iv) an event that impacts usage of the discrete object;
edges between the plurality of nodes corresponding to relationships between the objects of the system, wherein the relationships comprise (i) aggregation relationships between the plurality of objects, (ii) composition relationships between the plurality of objects; and (iii) dependencies between the plurality of objects;
receiving sensor data from one or more sensors monitoring activities associated with physical structures included in the system;
based on the sensor data, identifying an event impacting one or more objects performing a system function;
using the graph to generate an alternate system design which comprises a plurality of objects that are functionally equivalent to the impacted objects with respect to the system function; and
sending a transmittal comprising the alternate system design to one or more users.

12. The method of claim 11, further comprising:
using the edges included in the graph to generate one or more instructions for repurposing physical objects included in the system to implement the alternate system design.

13. The method of claim 11, further comprising:
identifying new relationships between objects included in the alternate system design; and
updating the graph with new edges representative of the new relationships.

14. The method of claim 11, further comprising:
identifying characteristics of the objects included in the alternate system design; and
updating the graph with one or more nodes representative of the characteristics.

15. The method of claim 11, wherein the alternate system design is generated by a process comprising:
creating a plurality of possible alternate system designs by traversing the graph starting at nodes corresponding to the impacted objects;
simulating the impacted system function with each of the plurality of possible alternate system designs to yield simulation results; and
based on the simulation results, selecting one of the possible alternate system designs as the alternate system design.

16. The method of claim 15, wherein the impacted system function is simulated using a system of simulations executing across a parallel computing architecture.

17. The method of claim 16, further comprising:
automatically combining a plurality of simulation models according to predetermined rules to create the system of simulations.

18. The method of claim 15, wherein the alternate system design is selected from the possible alternate system designs by:
ranking the possible alternate system designs according to one or more pre-determined criteria; and
selecting a highest ranking possible alternate system design as the alternate system design.

19. The method of claim 18, wherein the pre-determined criteria include a measurement of distance between objects included in each possible alternate design and the event impacting the objects performing the system function.

20. A system for providing adaptive resilience to a physical system, the system comprising:
a non-transitory computer reasonable readable medium storing a graph representative of objects included in a system, wherein the graph comprises:
a plurality of nodes, wherein each node is a programming component representing one or more of (i) a function performed by a discrete object included in the system; (ii) behaviors of the discrete object; (iii) a physical structure included in the discrete object; (iv) an event that impacts usage of the discrete object, and
edges between the plurality of nodes corresponding to relationships between the objects of the system, wherein the relationships comprise (i) aggregation relationships between the plurality of objects, (ii) composition relationships between the plurality of objects; and (iii) dependencies between the plurality of objects;
a plurality of device processors; and
a host processor configured to:
receive sensor data from one or more sensors monitoring activities associated with physical structures included in the system,
based on the sensor data, identify an event impacting one or more objects performing a system function,
create a plurality of possible alternate system designs by traversing the graph starting at nodes corresponding to the impacted objects,
use the device processors to simulate the impacted system function with each of the plurality of possible alternate system designs in parallel to yield simulation results, and
based on the simulation results, select one of the possible alternate system designs as an optimal alternate system design.
